(19) United States
(12) Patent Application Publication
(10) Pub. No.: US 2026/0250117 A1
(43) Pub. Date: Aug. 27, 2026

(54) DOUBLE-MOLD CONTINUOUS FILLING AND FORMING DEVICE, CONTROL METHOD THEREOF, AND FORMING AND SEALING UNIT OF SAME

(71) Applicant: TOFFLON SCIENCE AND TECHNOLOGY GROUP CO., LTD., Shanghai (CN)

(72) Inventors: Jianming Zou, Shanghai (CN); Qiming Wang, Shanghai (CN); Yunzheng Chen, Shanghai (CN)

(21) Appl. No.: 19/162,957

(22) PCT Filed: Sep. 21, 2023
(86) PCT No.: PCT/CN2023/120434

§ 371 Date: Sep. 8, 2025

(30) Foreign Application Priority Data
Mar. 31, 2023 (CN) 202310340798.3
Mar. 31, 2023 (CN) 202320704369.5
Sep. 15, 2023 (CN) 202311191632.6

(51) Int. Cl. B67C 7/00; B29C 49/42; B29L 31/00; B67C 3/22; B67C 3/24

(52) U.S. Cl. CPC B67C 7/00; B29C 49/42802; B29C 49/42809; B67C 3/24; B29L 2031/7158; B67C 2003/226; B67C 2003/227

(57) ABSTRACT

A double-mold continuous filling and forming device, comprising an inflatable-tubular-blank supplying unit, a forming and sealing unit, and a filling unit. The forming and sealing unit comprises a vertical movement mechanism and a mold-closing driving mechanism. A mold mounting portion is used for mounting a head mold, a middle mold and a bottom mold, which are arranged in sequence. A mold driving portion is configured to enable the head mold, the middle mold and the bottom mold to be independently and controllably opened and closed, and to enable the mold mounting portion to integrally move downwards from an initial position under the driving of the vertical movement mechanism, so as to sequentially form a first container body and seal the first container body to form a first container, and form a second container body and seal the second container body to form a second container.

### FIELD OF THE INVENTION

This invention relates to a filling and forming device that integrates blowing, filling, and sealing, and falls within the technical field of packaging equipment for food, pharmaceuticals, and other industries.

### BACKGROUND OF THE INVENTION

In the production process of existing blow-fill-seal integrated machines, the first step involves shaping the tubular blank extruded from the extruder die head within the bottle mold, i.e., the main mold, by using a power actuator to close and lock two parts of the bottle mold together and maintain pressure for a certain period. This allows the tubular blank to be shaped into the bottle body portion of the bottle product within the bottle mold through vacuum or air blowing. The second step is filling the already-formed bottle body portion. The third step is sealing, which involves using a power actuator to close and lock two parts of the head mold together and maintain pressure for a certain period, enabling the tubular blank to be shaped into the head portion of the bottle product within the head mold through vacuum or air blowing, thereby sealing the bottle product. Completing these three steps concludes the production of the bottle container. Typically, the extruder extrudes multiple tubular blanks arranged continuously in a row at once, known as a tubular blank sheet. Currently, conventional single-mold continuous blow-fill-seal equipment can only produce one sheet per production cycle, resulting in low overall machine capacity and an inability to achieve large-scale manufacturing. Therefore, there is an urgent need in this technical field to enhance the capacity of existing single-mold continuous equipment while reducing the later-stage maintenance and usage costs of the equipment to improve economic efficiency.

### SUMMARY OF THE INVENTION

One of the objectives of this invention is to provide a filing device that enhances the production capacity of existing single-mode continuous equipment.

To achieve the purpose of solving the aforementioned problems, this invention offers a dual-mold continuous filling and forming device, it comprises: an inflated tube blank providing unit configured to continuously provide inflated tube blanks; a molding and sealing unit configured to form sequentially form at least one first container body, seal the at least one first container body to form at least one first container, form at least one second container body, and seal the at least one second container body to form at least one second container; a filling unit configured to sequentially fill contents into the first container body and the second container at a filling height; wherein the molding and sealing unit comprises a vertical motion mechanism and a mold-closing driving mechanism coupled to the vertical motion mechanism; the mold-closing driving mechanism comprises a mold mounting portion and a mold driving portion, wherein the mold mounting portion is used for mounting a head mold, a middle mold, and a bottom mold arranged in sequence corresponding to the shapes of the first container and the second container; the mold driving portion is configured to enable the head mold, middle mold, and bottom mold to be individually controlled for opening and closing, and to enable the entire mold mounting portion to move downward from an initial position under the drive of the vertical motion mechanism to sequentially form the first container body, seal the first container body to form the first container, form the second container body, and seal the second container body to form the second container.

In some embodiments, the vertical motion mechanism is configured to, after closing the bottom mold, drive the mold mounting portion downward by a first distance, during which the filling unit fills contents into the formed first container body; and after closing the middle mold, drive the mold mounting portion downward by a third distance, during which the filling unit fills contents into the formed second container body.

The vertical motion mechanism is configured to, after driving the mold mounting portion downward by the first distance, drive the mold mounting portion downward by a second distance and then drive the closing of the middle mold; and after driving the mold mounting portion downward by the third distance, drive the mold mounting portion downward by a fourth distance and then drive the closing of the head mold.

In some embodiments, the mold driving portion is configured to drive all molds to open after the formation of the second container; and the vertical motion mechanism is configured to drive the mold mounting portion to return to the initial position after all molds are opened.

In some embodiments, it further comprises a protective frame, which is configured to have two rotatable arms, the two rotatable arms are configured to hold the inflated tube blank above the mold holding part before all molds are opened; and hold the inflated tube blank below the mold holding part before the bottom mold is closed.

In some embodiments, the mold mounting portion comprises a power mounting plate, a left mold-closing plate, a right mold-closing plate, a left main mold mounting plate with a left main mold, a right main mold mounting plate with a right main mold, a left head mold mounting plate with a left head mold, a right head mold mounting plate with a right head mold, a left bottom mold mounting plate with a left bottom mold, and a right bottom mold mounting plate with a right bottom mold; vertical left mold-closing plate and right mold-closing plate that can move horizontally left and right are respectively arranged on the left and right sides of the vertical power mounting plate; fixed left main mold mounting plate and right main mold mounting plate are respectively arranged on the left mold-closing plate and right mold-closing plate; left head mold mounting plate and right head mold mounting plate that can move horizontally left and right are respectively arranged on the upper sides of the left main mold mounting plate and right main mold mounting plate; left bottom mold mounting plate and right bottom mold mounting plate that can move horizontally left and right are respectively arranged on the lower sides of the left main mold mounting plate and right main mold mounting plate.

In some embodiments, the mold-closing driving mechanism comprises left and right swing arms, left and right lock mold power rotating shafts, left and right swing arm connecting rods, a hinge seat, a support rod, a transmission assembly, and a mold-closing power motor; a vertical lock mold power rotating shaft is respectively arranged on the left and right sides of the lock mold power transmission seat, and left and right swing arms are respectively mounted on the left and right lock mold power rotating shafts; the left and right swing arms are respectively connected to a movable hinge seat through left and right swing arm connecting rods; the hinge seat is movably sleeved on a support rod, and the hinge seat is connected to a mold-closing power motor through the telescopic shaft of the transmission assembly; the left and right swing arms are respectively connected to left and right mold groups; the mold-closing driving mechanisms of the three mold-closing units share the left and right lock mold power rotating shafts.

In some embodiments, the vertical motion mechanism comprises a lock mold power transmission seat, a lock mold screw rod, and a lock mold power motor; the lock mold power motor is connected to the lock mold screw rod, and the lock mold power transmission seat is arranged on the moving nut of the lock mold screw rod; the lock mold power transmission seat is connected to the mold-closing driving mechanism.

Some other embodiments of this application provide a control method for a dual-mold continuous filling and forming device, it comprises the following steps: first, close a bottom mold to form a first container body from the first section of a continuous inflated tube blank, and after the bottom mold is closed, a vertical motion mechanism drives the entire mold-closing driving mechanism downward by a first distance, and then control a filling needle of the filling unit to fill contents into the first container body; then, drive the vertical motion mechanism to drive the entire mold-closing driving mechanism downward by a second distance so that the filling needle enters the mold position corresponding to a second container body; next, drive the closing of a middle mold so that the lower part of the middle mold seals the first container body to form the first container, and at the same time, when the middle mold is closed, the second section of the inflated tube blank above the first section is formed into a second container body, during this process, drive the vertical motion mechanism to drive the entire mold-closing driving mechanism downward by a third distance, and then control the filling needle to fill contents into the second container body; then, drive the vertical motion mechanism to drive the entire mold-closing driving mechanism downward by a fourth distance so that the filling needle leaves the height position of the second container body, and then drive the closing of the head mold to seal the second container body to obtain the second container with liquid.

Some other of this application also provide a molding and sealing unit of a dual-mold continuous filling and forming device, the molding and sealing unit is configured to sequentially form a first container body, seal the first container body to form a first container, form a second container body, and seal the second container body to form a second container; wherein the molding and sealing unit comprises a vertical motion mechanism and a mold-closing driving mechanism coupled to the vertical motion mechanism; the mold-closing driving mechanism comprises a mold mounting portion and a mold driving portion, wherein the mold mounting portion is used for mounting a head mold, a middle mold, and a bottom mold arranged in sequence corresponding to the shapes of the first container and the second container; the mold driving portion is configured to enable the head mold, middle mold, and bottom mold to be individually controlled for opening and closing, and to enable the entire mold mounting portion to move downward under the drive of the vertical motion mechanism to continuously form the first container body, seal the first container body to form the first container, form the second container body, and seal the second container body to form the second container.

Compared with the devices and methods in the prior art, the present invention offers the following advantageous effects: By utilizing the dual-mode continuous filling device provided by this invention, not only can the production capacity of the entire equipment be doubled compared to that of single-mode continuous equipment, but also the maintenance and operational costs of the equipment in later stages are lower. In some embodiments, continuous high-quality production of products can be achieved, enhancing economic benefits. Some embodiments of this invention feature simple structures, convenient control, energy efficiency, and ease of implementation, enabling large-scale manufacturing and significantly improving production efficiency.

### BRIEF DESCRIPTION OF THE DRAWINGS

FIG. 1 is a front view of the mold mounting portion of the dual-mode continuous filling and forming device according to the present application (the mold in the figure is shown in the open state).

FIG. 2 is a top view of the mold mounting portion of the dual-mode continuous filling and forming device according to the present application.

FIG. 3 is a bottom view of the mold mounting portion of the dual-mode continuous filling and forming device according to the present application.

FIG. 4 is a left side view of the mold mounting portion of the dual-mode continuous filling and forming device according to the present application.

FIG. 5 is an isometric view of the mold mounting portion of the dual-mode continuous filling and forming device according to the present application.

FIG. 6 is a side cross-sectional view of the molding and sealing unit of the dual-mode continuous filling and forming device according to the present application, with the mold mounting portion removed.

FIG. 7 is a top view of the molding and sealing unit of the dual-mode continuous filling and forming device according to the present application, with the mold mounting portion removed.

FIG. 8 is a rear view of the molding and sealing unit of the dual-mode continuous filling and forming device according to the present application, with the mold mounting portion removed.

FIG. 9 is a front view of the molding and sealing unit of the dual-mode continuous filling and forming device according to the present application, with the mold mounting portion removed.

FIG. 10 is an isometric view of the molding and sealing unit of the dual-mode continuous filling and forming device according to the present application, with the mold mounting portion removed.

FIG. 11 is an isometric view of the dual-mode continuous filling and forming device according to the present application.

FIG. 12 is a partial cross-sectional top view of the dual-mode continuous filling and forming device according to the present application.

FIGS. 13 to 24 are schematic figures illustrating the working process of the dual-mode continuous filling and forming device according to the present application.

FIG. 25 is a schematic figure showing the position of the filling needle in the dual-mode continuous filling and forming device according to the present application.

FIG. 26 is a schematic figure of the filling unit and the air-filled tube blank supply unit in the dual-mode continuous filling and forming device according to the present application.

The reference numerals in the drawings are as follows:

Left mold group 1, containing left head mold 1-1, left middle mold 1-2, and left bottom mold 1-3; Right mold group 2 containing right head mold 2-1, right middle mold 2-2, and right bottom mold 2-3; Power mounting plate 3; First guiding unit 4 containing first slider 4-1 and first guide rail 4-2; Second guiding unit 5 containing second slider 5-1 and second guide rail 5-2; Left mold-closing plate 6; Right mold-closing plate 7; Left middle mold mounting plate 8; Right middle mold mounting plate 9; Left head mold mounting plate 10; Right head mold mounting plate 11; Left bottom mold mounting plate 12; Right bottom mold mounting plate 13; Third guiding unit 14 containing third slider 14-1 and third guide rail 14-2; Fourth guiding unit 15 containing fourth slider 15-1 and fourth guide rail 15-2; motor fixed seat 20; Holder drive screw bearing base 21; lock mold transmission screw bearing seat 22; Motor mounting base 23; Holder reducer 24; lock mold reducer 25; Holder power motor 26; lock mold power motor 27; Holder coupling 28; lock mold coupling 29; Holder screw bearing 30; lock mold screw bearing 31; Holder screw 32 containing first screw nut 32-1 and first screw body 32-2; lock mold screw 33 containing second screw nut 33-1 and second screw body 33-2; Holder mounting base 34; lock mold power transmission base 35; First lock mold power rotating shaft 36-1; Second lock mold power rotating shaft 36-2; First bottom mold mold-closing swing arm 37-1; Second bottom mold mold-closing swing arm 37-2; First middle mold mold-closing swing arm 38-1; Second middle mold mold-closing swing arm 38-2; First head mold mold-closing swing arm 39-1; Second head mold mold-closing swing arm 39-2; First rotating shaft retaining plate 40-1; Second rotating shaft retaining plate 40-2; Third rotating shaft retaining plate 40-3; Fourth rotating shaft retaining plate 40-4; Fifth rotating shaft retaining plate 40-5; Sixth rotating shaft retaining plate 40-6; Seventh rotating shaft retaining plate 40-7; Eighth rotating shaft retaining plate 40-8; Ninth rotating shaft retaining plate 40-9; First screw bearing base 41-1; Second screw bearing base 41-2; First screw bearing 42-1; Second screw bearing 42-2; First head mold slider 43-1; Second head mold slider 43-2; First middle mold slider 44-1; Second middle mold slider 44-2; First bottom mold slider 45-1; Second bottom mold slider 45-2; Motor support plate 46; First motor support rod 47-1; Second motor support rod 47-2; Third motor support rod 47-3; First hinge seat 48-1; Second hinge seat 48-2; Third hinge seat 48-3; Motor mounting plate 49; Head mold power transmission assembly 50; Head mold power motor 51; Middle mold power transmission assembly 52; Middle mold power motor 53; Bottom mold power transmission assembly 54; Bottom mold power motor 55; First head mold link 56-1; Second head mold link 56-2; First middle mold link 57-1; Second middle mold link 57-2; First bottom mold link 58-1; Second bottom mold link 58-2; Bottom mold hinge seat pin 59; First connecting nut 60-1; Second connecting nut 60-2; Third connecting nut 60-3; First head mold slider pin 61-1; Second head mold slider pin 61-2; First middle mold slider pin 62-1; Second middle mold slider pin 62-2; First bottom mold slider pin 63-1; Second bottom mold slider pin 63-2; Head mold hinge seat pin 64; Middle mold hinge seat pin 65; First head mold link pin 66-1; Second head mold link pin 66-2; First middle mold link pin 67-1; Second middle mold link pin 67-2; First bottom mold link pin 68-1; Second bottom mold link pin 68-2; Holder assembly 69; Inflatable tubular blank providing unit 100, Inflatable tubular blank 101; Die head assembly 102; Filling unit 200; Filling needle 201.

### DETAILED DESCRIPTION OF THE EMBODIMENTS

To render the present invention more comprehensible, detailed descriptions are hereby provided with reference to preferred embodiments and accompanying drawings. In the descriptions of this application, it should be noted that terms indicating directions or positional relationships, such as “center”, “upper”, “lower”, “left”, “right”, “vertical”, “horizontal”, “inner”, and “outer” are based on the directions or positional relationships shown in the drawings. These terms are used merely for the convenience of describing the present invention and simplifying the descriptions, rather than indicating or implying that the referred devices or elements must have specific directions or be constructed and operated in specific directions. Therefore, they should not be construed as limiting the present invention. Additionally, terms like “first”, “second”, and “third” are used solely for descriptive purposes and should not be interpreted as indicating relative importance.

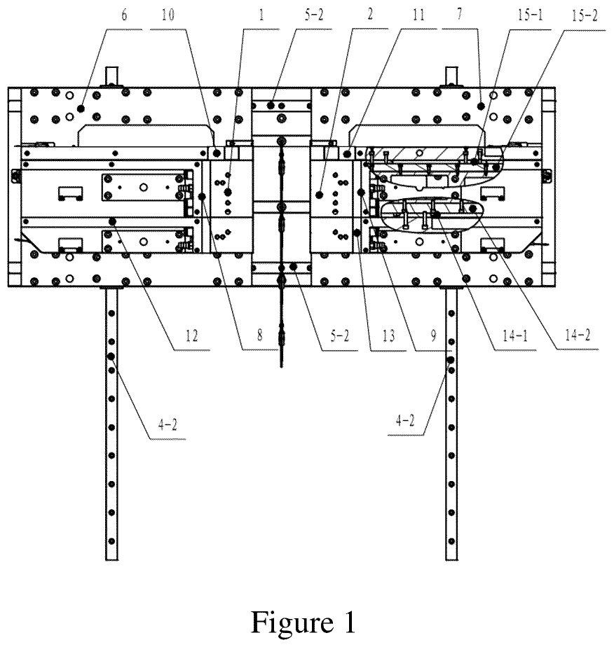

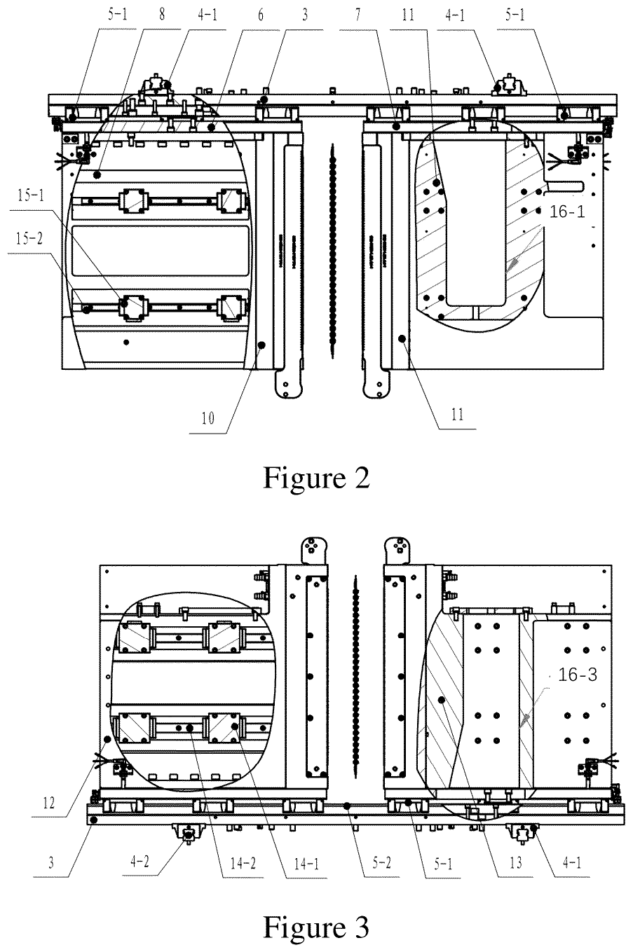

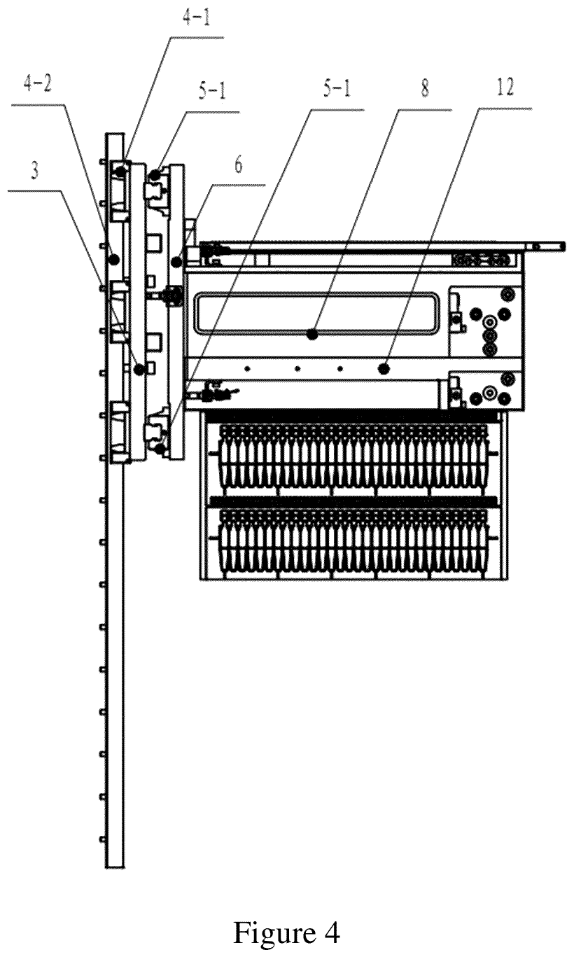

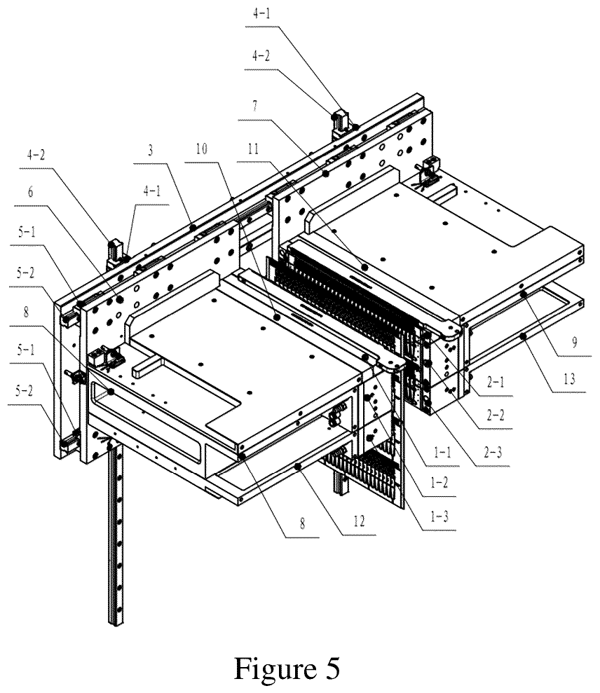

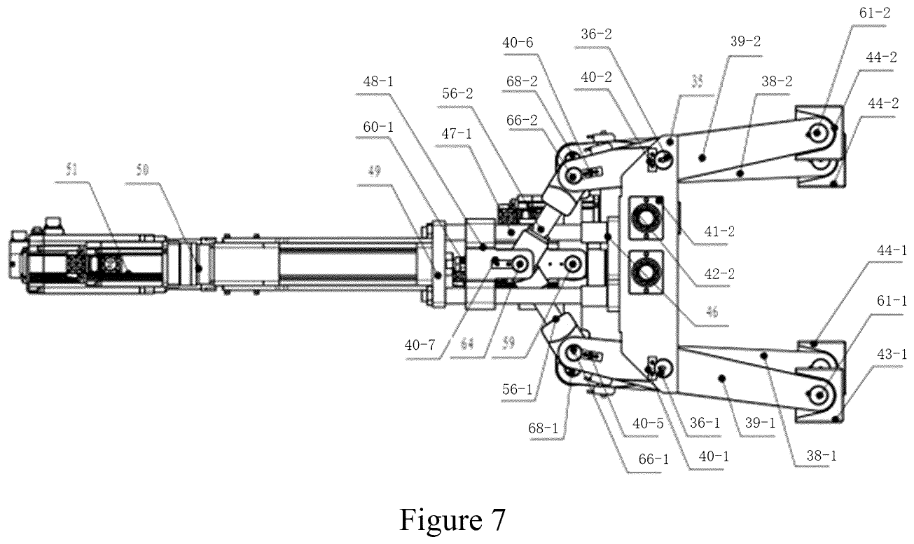

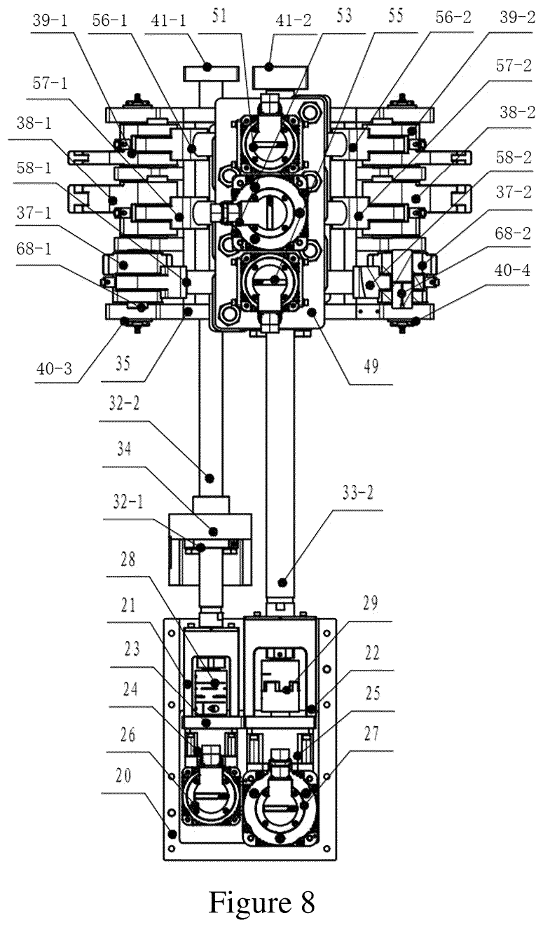

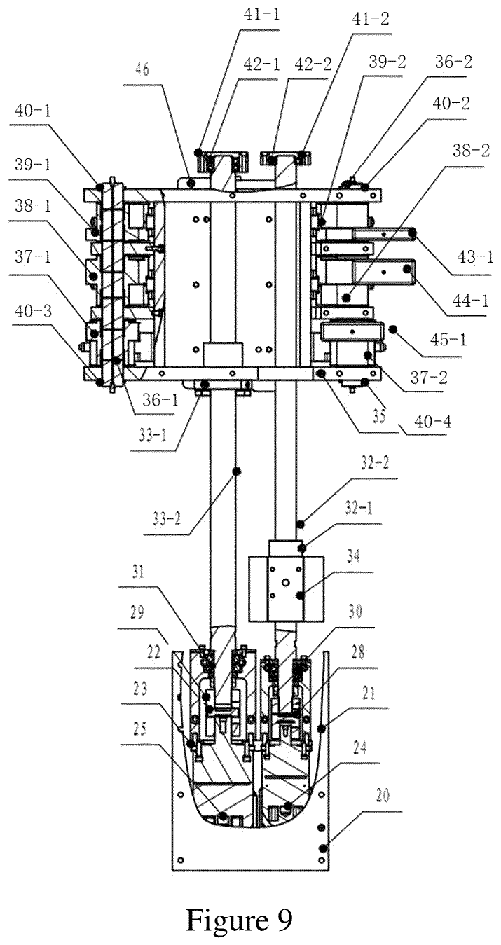

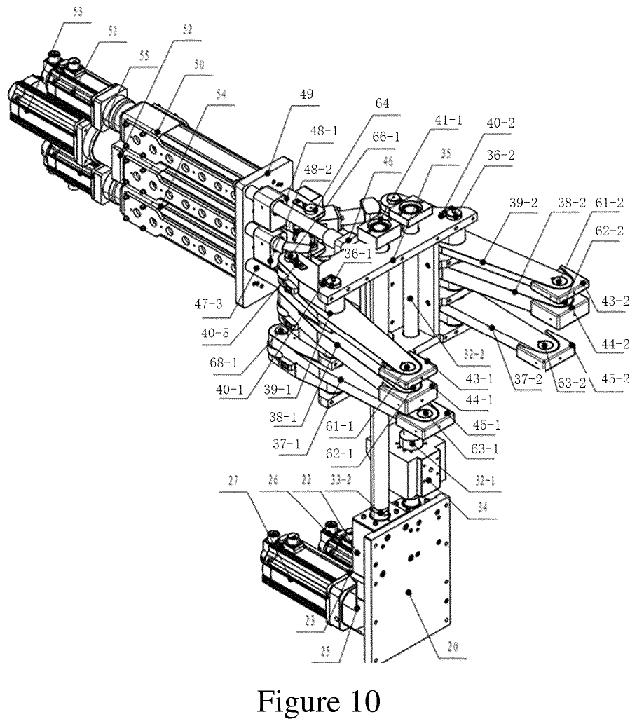

As shown in FIGS. 1 to 12, some embodiments of the present invention provide a double-mold continuous filling and forming device applicable to a blow-fill-seal integrated machine, comprising an inflatable-tubular-blank providing unit 100 for providing an inflatable tubular blank 101, a forming and sealing unit for shaping the inflatable tubular blank to form a container body and sealing the filled container body to form a liquid-containing container, and a filling unit 200 for filling the shaped container body.

Herein, the forming and sealing unit adopts a double-mold structure, where double mold refers to providing two complete sets of container molds for forming container products, such as bottles. The double molds can be two sets of container molds arranged vertically, with each set consisting of a container body mold and a sealing mold above the container body mold. Both the container body mold and the sealing mold are formed by mold closing, with each mold divided into a left mold and a right mold. The left and right molds close to form the desired container body mold or sealing mold. Due to the presence of two sets of container molds, the lower container mold is referred to as the first container mold, and the upper container mold is referred to as the second container mold. The container body mold and sealing mold of the first container mold are referred to as the first container body mold and the first sealing mold, respectively, while those of the second container mold are referred to as the second container body mold and the second sealing mold, respectively. In this application, the first sealing mold is located below the second container body mold, and they can be adjacent, such as being located on the same mold block, while the first container body mold and the second sealing mold are different mold blocks.

For convenience of description, the first container body mold can be referred to as the bottom mold, the block containing the first sealing mold and the second container body mold can be referred to as the middle mold, and the second sealing mold can be referred to as the head mold. As mentioned above, each mold consists of two parts and is driven to have two states: mold closing and mold opening. In the mold-closed state, the two parts of the mold combine to form a cavity that defines the outer profile of the container to be shaped. In the mold-open state, the two parts separate, allowing the shaped container to be released from the mold. For convenience of description, in this application, each mold is divided into left and right parts based on the midline of mold opening and closing as the reference line. Accordingly, the left half of the head mold is referred to as the left head mold 1-1, the right half as the right head mold 2-1, the left half of the middle mold as the left middle mold 1-2, the right half as the right middle mold 2-2, the left half of the bottom mold as the left bottom mold 1-3, and the right half as the right bottom mold 2-3. The head mold is also referred to as a pair of head molds, the middle mold as a pair of middle molds, and the bottom mold as a pair of bottom molds.

It should be understood that the designation of left and right parts is for convenience of description only. Depending on the reference line, the two parts of each mold can also be defined as front and back parts or upper and lower parts, or more generally as a first part and a second part, which have the same meaning.

In addition to the bottom mold, middle mold, and head mold, the forming and sealing unit also includes a mold-closing driving mechanism and a vertical movement mechanism. The mold-closing driving mechanism can be integrally placed on the vertical movement mechanism and can be driven by the vertical movement mechanism to move vertically in a controlled linear reciprocating motion. The mold-closing driving mechanism is equipped with the bottom mold, middle mold, and head mold and drives the head mold, middle mold, and bottom mold to open and close according to the drive logic. Thus, the mold-closing driving mechanism includes a mold mounting portion and a head mold drive mechanism, middle mold drive mechanism, and bottom mold drive mechanism coupled with the mold mounting portion. Pairs of head molds, middle molds, and bottom molds are sequentially mounted in pairs within the mold mounting portion. The mold mounting portion can include a head mold mounting portion coupled with the head mold drive mechanism and driven by the head mold drive mechanism to open and close, a middle mold mounting portion coupled with the middle mold drive mechanism and driven by the middle mold drive mechanism to open and close, and a bottom mold mounting portion coupled with the bottom mold drive mechanism and driven by the bottom mold drive mechanism to open and close.

The inflatable-tubular-blank providing unit 100 is used to perform a blowing operation on a molten material to form a supported tubular blank. Specifically, it typically includes an extruder and a blowing device. Solid plastic pellets enter from the feed inlet of the extruder and are continuously extruded towards the extruder die head assembly 102 under the rotation of a screw. At the same time, the solid plastic pellets are melted under the action of a temperature-controlled heating element to form a molten state and continue to be extruded towards the extruder die head assembly. The molten plastic pellets flow in the channels of the die head assembly and are extruded from the end of the die head channels out of the extruder in a tubular shape, i.e., as a tubular blank. Meanwhile, sterile gas is blown into the continuously extruded tubular blank using the blowing device to support and protect the tubular blank, forming a continuous inflatable tubular blank 101.

Typically, the inflatable tubular blanks are provided in rows in the depth direction, i.e., the front-back direction relative to the left-right and up-down directions, and correspondingly, each set of molds also has forming cavities arranged in rows in the depth direction. Of course, the inflatable tubular blank can also be a single tubular blank, and the corresponding mold also has a single forming cavity. Thus, in this application, when explaining the action process, terms such as first container body, first container, second container body, and second container refer to either a single container or container body formed in the same step or a row of containers or container bodies formed in the same step.

It should be understood that the action of the forming and sealing unit on the continuous inflatable tubular blank is cyclic. Specifically, for a given length of the inflated tube blank, the unit operates in two stages—acting on two segmented portions of that length to form the first container and the second container, respectively.

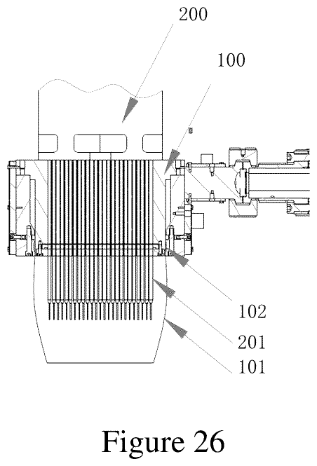

The filling unit 200 can be in the form of a filling mechanism disclosed in the Chinese invention patent application with publication number CN113929041A and titled “Container Filling Device Suitable for a Machine that Integrates Blowing, Filling, and Sealing,” which is incorporated herein by reference in its entirety. The filling unit 200 provides a filling needle 201 to fill the formed first container body and second container body, as shown in FIGS. 25 and 26. For example, the filling needle can be located inside the continuous inflatable tubular blank and set at a fixed height to sequentially perform filling operations on the first container body and second container body that move downward relative to it. After filling is complete, the filling needle leaves the position corresponding to the first container head of the first container body or the second container head of the second container body, so as not to interfere with the sealing operation of the forming and sealing unit on the first container body and second container body, respectively.

In some embodiments, to better shape and release the molds, all molds are equipped with cooling components and vacuum components. The cooling components are used to reduce the temperature of the liquid extruded from the extruder, while the vacuum components are mainly used to adhere the inflatable tubular blank to the mold before shaping and to release it from the mold after shaping to assist in filling. For example, the cooling component can be connected to the mold mounting portion to reduce the high temperature of the three molds. Since the molds in this application are used for the fusion shaping of plastic pellets, which require a high temperature, the basic inflatable tubular blank carries a high temperature. At the same time, the filling needle is constantly in a high-temperature environment, and the filled liquid also belongs to a high-temperature category. To ensure better cooling and shaping of the mold mounting portion, providing cooling components to the mold mounting portion for cooling is the most effective method.

For another example, the vacuum component can include suction cups arranged on the inner surfaces of the cavities of the head mold, middle mold, and bottom mold that form the container body, as well as a vacuum pump coupled with the suction cups. The suction cups adhere the shaped container body to the mold under the action of the vacuum pump for positioning. After the left and right parts of any mold are opened, the suction cups blow air in the opposite direction to separate the first container or second container from the mold. The suction cups used herein have dimensions ranging from micrometers to millimeters and are almost invisible to the naked eyes, without affecting the shaping of the inflatable tubular blank.

Since the filling device of this application has two sets of container molds, the first and the second, it has unique mold closing and opening control. For example, first, the bottom mold is closed to shape the first inflatable tubular blank segment into the first container body. Since shaping the inflatable tubular blank into the first container body takes a certain amount of time and the first container body needs to be moved away from the filling needle position for shaping and filling of the second container body, after the bottom mold is closed, the vertical movement mechanism drives the mold-closing driving mechanism to move downward as a whole by a first distance to form the first container body. Then, the filling unit's filling needle fills the contents, such as a fluid, especially a liquid, especially a pharmaceutical liquid, into the first container body. After that, the vertical movement mechanism is driven to move the mold-closing driving mechanism downward as a whole by a second distance so that the filling needle does not interfere with the sealing of the first container body. Then, the middle mold is closed to seal the first container body by the lower part of the middle mold to form the first container. At the same time, since the middle mold not only has the sealing mold of the first container mold but also has the container body mold of the second container mold above it, when the middle mold is closed, it also shapes the second inflatable tubular blank segment above the first inflatable tubular blank segment into the second container body. During this process, the vertical movement mechanism is driven to move the mold-closing driving mechanism downward as a whole by a third distance to form the second container body. Then, the filling unit's filling needle fills the contents into the second container body. After that, the vertical movement mechanism is driven to move the mold-closing driving mechanism downward as a whole by a fourth distance so that the filling needle leaves the height position of the second container body. Then, the head mold is closed to seal the second container body to obtain the second container with liquid.

It should be understood that to pursue high efficiency, during the above process, the filling of contents can be synchronized with the downward movement of the molds, and the filling speed can be controlled so that filling is completed when the descent processes for the aforementioned first and third distances are finished. Of course, other filling speeds can also be used, such as waiting for the filling needle to complete filling after descending the first and third distances before proceeding with subsequent operations.

It can be seen that when the dimensions of the first container and the second container are the same, the first and the third distances can be equal, and the second and the fourth distances can be equal. If the dimensions of the first container and the second container are different, the aforementioned first and third distances can be controlled to be unequal, and the second and fourth distances can be controlled to be unequal. If the dimensions of the first container and the second container are different, the filling speed and descent time can also be correspondingly controlled to match the different container dimensions.

To improve shaping accuracy, a holder for the inflatable tubular blank can be set to maintain the position of the inflatable tubular blank from when the molds are fully opened to before the bottom mold is closed. During this process, the holder for the inflatable tubular blank avoids the mold-closing driving mechanism and molds by rotating horizontally, moves up to a position above the head mold, and clamps and holds the continuous inflatable tubular blank. Under the holding of the holder, the three sets of molds, the head mold, middle mold, and bottom mold, are fully opened and driven to rise to the initial position where the bottom mold shapes the inflatable tubular blank before performing bottom mold closing and shaping, forming a cycle.

The control method for the double-mold continuous filling and forming device based on a blow-fill-seal integrated machine can be implemented by executing a computer program, such as by programming a controller to control the operation of each unit and its controlled components to cyclically move among the steps of shaping the container body, filling the contents, and sealing the container.

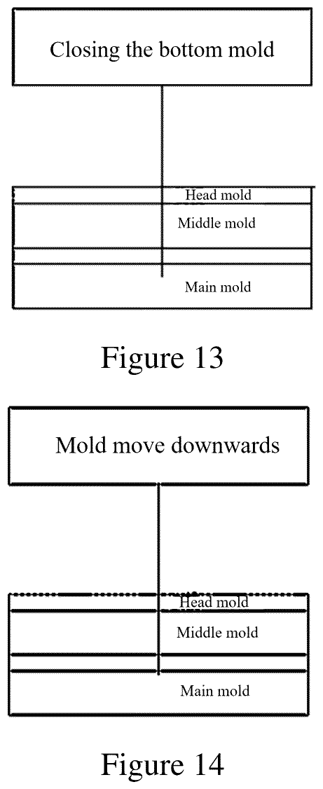

An exemplary control method for a double-mold continuous filling and forming device for a blow-fill-seal integrated machine according to an embodiment of this application can include the following steps S1 to S5, as shown in FIGS. 13 to 24, where the time when shaping of the first container begins is designated as T0, and the time when shaping of the second container ends is designated as Tn; the initial height of the mold mounting portion is designated as H0, and the final mold height is designated as Hn. The vertical lines in the figures indicate the position of the filling needle.

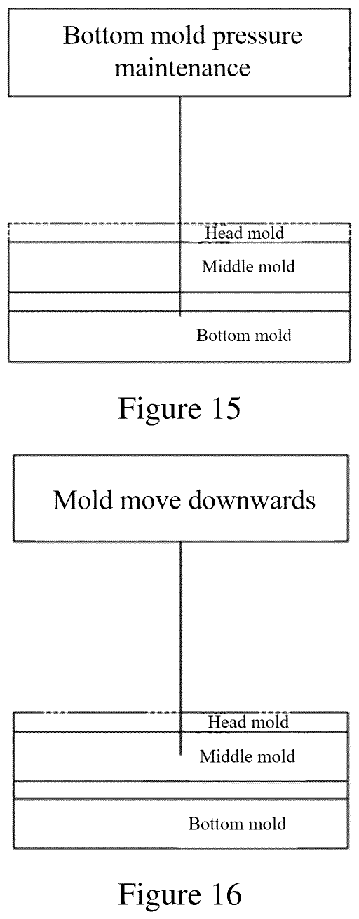

Step S1: Shaping the first container body of the first container, including extruding a tubular blank from the inflatable-tubular-blank providing unit and blowing air into the tubular blank to form a continuous inflatable tubular blank, as well as transmitting the inflatable tubular blank downward at a set speed. The filling needle of the filling unit is driven to the filling height and remains stationary. The mold mounting portion reaches the initial height H0. For example, at this height H0, the position of the bottom mold matches the height of the filling needle HF, such as the filling needle being located within the height range of the bottom mold, close to the bottom of the bottom mold. As shown in FIG. 13, after the above preparations are completed and the time reaches the bottom mold closing time T0, the forming and sealing unit performs bottom mold closing to shape the first inflatable tubular blank segment into the first container body. The process of forming the first container body includes the vertical movement mechanism of the forming and sealing unit driving the mold mounting portion to move downward as a whole by a first distance H1. During this process, the filling needle fills the first container body, and when filling is complete, the filling needle is exactly at the height of the top opening of the first container body. The duration of the descent can be, for example, T1, as shown in FIG. 14. Then, the mold mounting portion is driven to move downward as a whole by a second distance H2 for a duration of T2, so that the filling needle leaves the sealing height of the first container, i.e., the filling needle leaves the first container sealing mold which is in the lower part of the middle mold and enters the portion of the second container body mold which is upper, as shown in FIG. 16. Optionally, before moving downward by the second distance, the pressure of the bottom mold can be maintained for a period of time, during which the holder can be driven to move upward, as shown in FIG. 15.

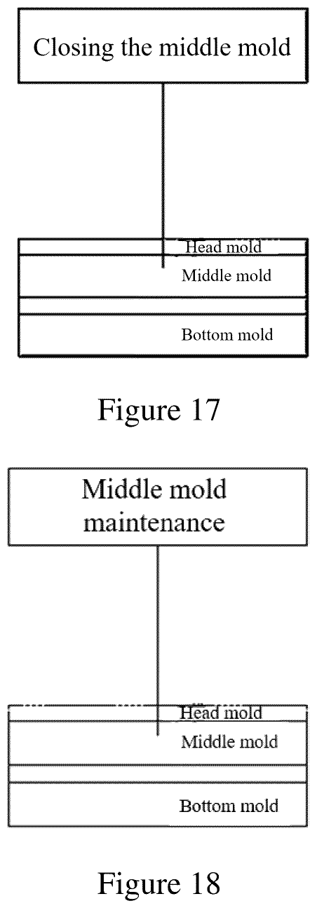

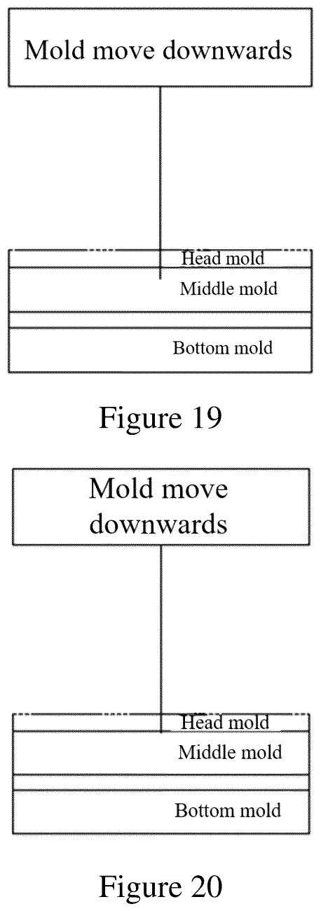

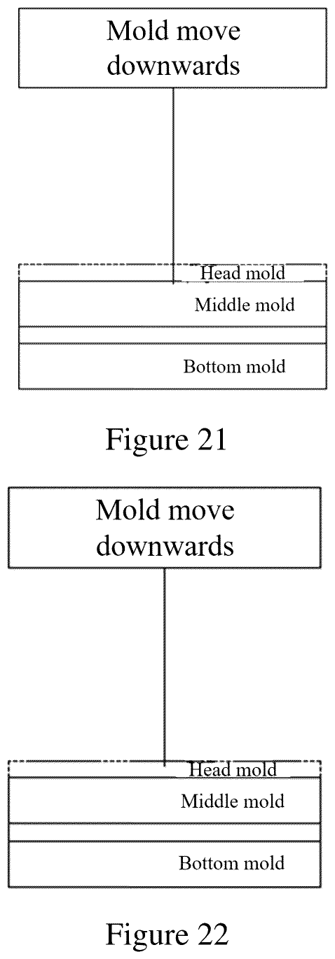

Step S2: Sealing the first container and shaping the container body of the second container: including, after the filling needle leaves the first container sealing mold which is in the lower part of the middle mold and enters the second container body mold which is upper, controlling the mold-closing driving mechanism to perform middle mold closing for a duration of T3. The lower part of the middle mold seals the first container body, while the upper part forms the second container body, as shown in FIG. 17. The vertical movement mechanism of the forming and sealing unit drives the mold mounting portion to move downward as a whole by a third distance H3. During this process, the filling needle fills the second container body, and when filling is complete, the filling needle is exactly at the height of the top opening of the second container body. The duration of the descent can be, for example, T4, as shown in FIG. 19. Then, the mold mounting portion is driven to move downward as a whole by a fourth distance H4 for a duration of T5. After experiencing the processes shown in FIGS. 20 and 21, the filling needle leaves the sealing height of the second container, i.e., the filling needle leaves the upper surface position of the head mold, as shown in FIG. 22. Before driving the main mold to move downward by the third distance, the pressure of the main mold can be maintained, as shown in FIG. 18.

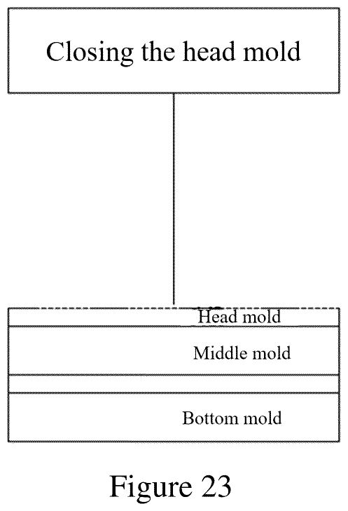

Step S3: Sealing the second container: after the mold mounting portion moves downward by the fourth distance H4 to reach the final mold height Hn, the head mold is driven to close for sealing the second container. After T6 time, the head mold completes sealing the second container, as shown in FIG. 22. During this process, the holder can be driven to move to a position above the head mold and hold the inflatable tubular blank, as shown in FIG. 23.

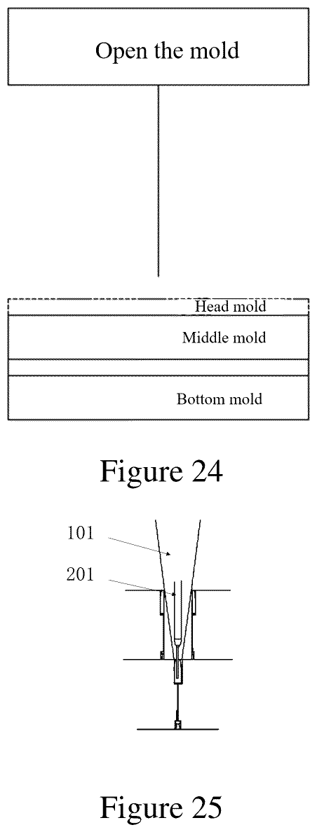

Step S5: Resetting the mold mounting portion: after sealing the second container is completed, the head mold, middle mold, and bottom mold are fully opened to leave a channel around the holder and the inflatable tubular blank. After that, the mold mounting portion is driven to move upward as a whole with all molds to reset to the initial height H0, as shown in FIG. 24. After that, bottom mold closing can be performed again. After closing is completed, the holder releases the inflatable tubular blank and no longer holds it.

Steps S1 to S5 can be cycled to cyclically produce the first container and the second container.

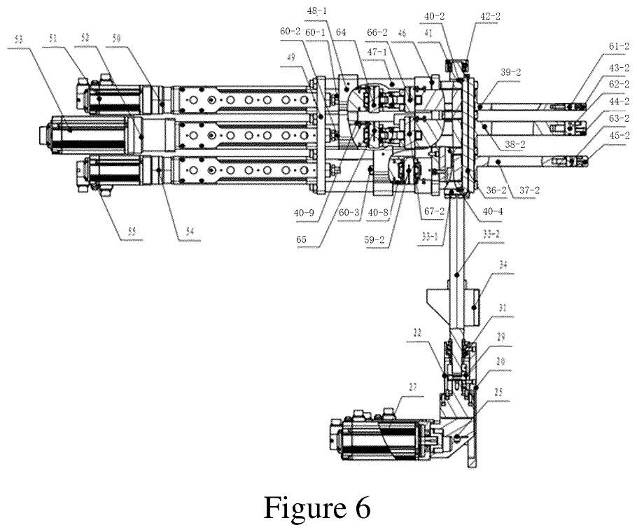

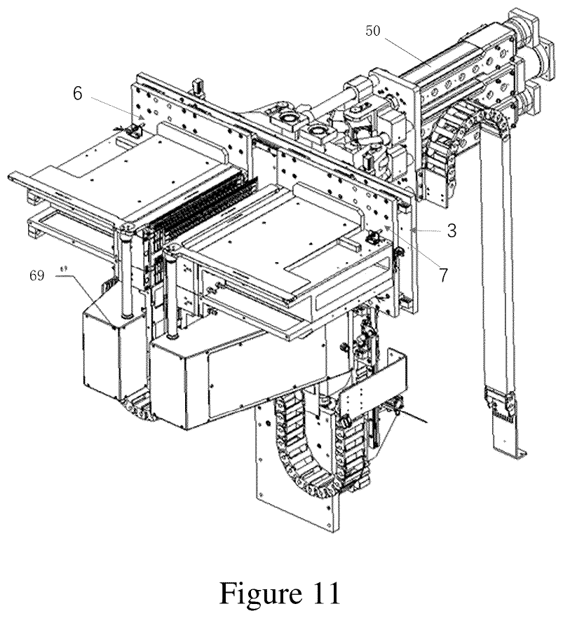

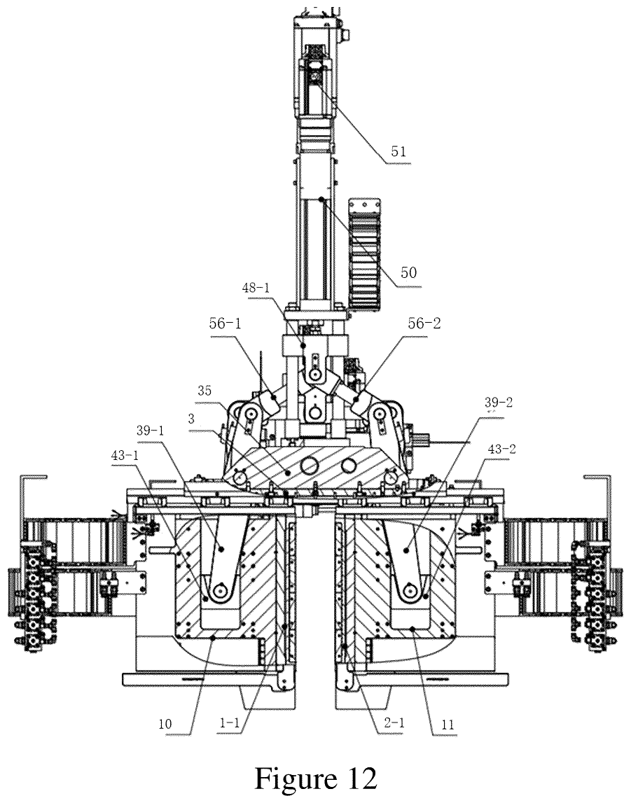

The forming and sealing unit of this application can have various structural arrangements. FIGS. 1 to 5 show structural figures of the mold mounting portion in the mold-closing driving mechanism of the forming and sealing unit from different observation directions. FIGS. 6 to 10 show structural figures of the mold drive portion and the vertical movement mechanism of the mold-closing driving mechanism of the forming and sealing unit from different observation directions. FIG. 11 is an overall axonometric view of the forming and sealing unit. FIG. 12 is a top cross-sectional view of FIG. 11.

mold-closing driving mechanism:

The mold-closing driving mechanism can include a mold mounting portion and a head mold closing drive portion, middle mold closing drive portion, and bottom mold closing drive portion that drive the mold mounting portion to move.

The mold mounting portion includes a base group for mounting the left mold group and the right mold group; the base group includes a power mounting plate 3, a left closing plate 6, a right closing plate 7, a left middle mold mounting plate 8 with a left middle mold 1-2, a right middle mold mounting plate 9 with a right middle mold 2-2, a left head mold mounting plate 10 with a left head mold 1-1, a right head mold mounting plate 11 with a right head mold 2-1, a left bottom mold mounting plate 12 with a left bottom mold 1-3, and a right bottom mold mounting plate 13 with a right bottom mold 2-3; vertically arranged left and closing plate 6 and right closing plate 7 are provided on the left and right sides of the vertical power mounting plate 3, respectively, and can move horizontally left and right; the left closing plate 6 and the right closing plate 7 are equipped with fixed left middle mold mounting plates 8 and right middle mold mounting plates 9, respectively; the upper sides of the left middle mold mounting plate 8 and the right middle mold mounting plate 9 are equipped with left head mold mounting plates 10 and right head mold mounting plates 11, respectively, which can move horizontally left and right; the lower sides of the left middle mold mounting plate 8 and the right middle mold mounting plate 9 are equipped with left bottom mold mounting plates 12 and right bottom mold mounting plates 13, respectively, which can move horizontally left and right.

The left head mold 1-1 is fixed on the left head mold mounting plate 10, the left middle mold 1-2 is fixed on the left middle mold mounting plate 8, the left bottom mold 1-3 is fixed on the left bottom mold mounting plate 12, the right head mold 2-1 is fixed on the right head mold mounting plate 11, the right middle mold 2-2 is fixed on the right middle mold mounting plate 9, and the right bottom mold 2-3 is fixed on the right bottom mold mounting plate 13, allowing the left head mold 1-1 and the right head mold 2-1 to move horizontally left and right along the fourth guide rails 15-2 of the fourth guide unit 15, the left middle mold 1-2 and the right middle mold 2-2 to move horizontally left and right along the second guide rails 5-2 of the second guide unit 5, and the left bottom mold 1-3 and the right bottom mold 2-3 to move horizontally left and right along the third guide rails 14-2 of the third guide unit 14.

Wherein, the second guide rails 5-2 of the second guide unit 5 are horizontally fixed on the power mounting plate 3, and the left closing plate 6 is fixed on the second sliders 5-1, allowing the left closing plate 6 to move horizontally left and right along the second guide rails 5-2. Similarly, the right closing plate 7 is fixed on the second sliders 5-1, allowing the right closing plate 7 to move horizontally left and right along the second guide rails 5-2. The left middle mold mounting plate 8 is fixed on the left closing plate 6, and the right middle mold mounting plate 9 is fixed on the right closing plate 7, allowing the left middle mold mounting plate 8 and the right middle mold mounting plate 9 to move horizontally left and right along the second guide rails 5-2. The fourth guide rails 15-2 of the fourth guide unit 15 are fixed in the upper grooves of the left middle mold mounting plate 8 and the right middle mold mounting plate 9, and the left head mold mounting plate 10 is fixed on the fourth sliders 15-1 of the fourth guide unit 15, allowing the left head mold mounting plate 10 to move horizontally left and right along the fourth guide rails 15-2. The right head mold mounting plate 11 is fixed on the fourth sliders 15-1 of the fourth guide unit 15, allowing the right head mold mounting plate 11 to move horizontally left and right along the fourth guide rails 15-2. The third guide rails 14-2 of the third guide unit 14 are fixed in the lower grooves of the left middle mold mounting plate 8 and the right middle mold mounting plate 9, and the left bottom mold mounting plate 12 is fixed on the third sliders 14-1 of the third guide unit 14, allowing the left bottom mold mounting plate 12 to move horizontally left and right along the third guide rails 14-2. The right bottom mold mounting plate 13 is fixed on the third sliders 14-1 of the third guide unit 14, allowing the right bottom mold mounting plate 13 to move horizontally left and right along the third guide rails 14-2.

Specifically, the mold drive portion includes a first swing arm group, a second swing arm group, a first lock mold power rotating shaft 36-1, a second lock mold power rotating shaft 36-2, a first connecting rod group, a second connecting rod group, a hinge seat 48, a support rod 47, a transmission assembly, and a mold closing power motor. Among them, the first swing arm group includes a first head mold closing swing arm, a first middle mold closing swing arm, and a first bottom mold closing swing arm, while the second swing arm group includes a second head mold closing swing arm, a second middle mold closing swing arm, and a second bottom mold closing swing arm. The first connecting rod group includes a first head mold connecting rod, a first middle mold connecting rod, and a first bottom mold connecting rod, while the second connecting rod group includes a second head mold connecting rod, a second middle mold connecting rod, and a second bottom mold connecting rod.

On the left and right sides of the lock mold power transmission seat 35, there are vertical lock mold power rotating shafts, namely, the left lock mold power rotating shaft, also referred to as the first lock mold power rotating shaft 36-1 in this article, and the right lock mold power rotating shaft, also referred to as the second lock mold power rotating shaft 36-2 in this article. The first lock mold power rotating shaft 36-1 is threaded with the first swing arm group, and the second lock mold power rotating shaft 36-2 is threaded with the second swing arm group. The swing arms in the first swing arm group are respectively connected to the movable hinge seats 48 through the corresponding connecting rods in the first connecting rod group, and the swing arms in the second swing arm group are respectively connected to the hinge seats 48 through the corresponding connecting rods in the second connecting rod group. The hinge seats 48 are movably sleeved on the support rod 47 and connected to the mold closing power motor through the telescopic shaft of the transmission assembly. The left swing arm group and the right swing arm group are respectively connected to the left mold group and the right mold group.

The left head mold mounting plate 10 and the right head mold mounting plate 11 are connected to the head mold closing drive portion through the first head mold closing swing arm and the second head mold closing swing arm. The left middle mold mounting plate 8 and the right middle mold mounting plate 9 are connected to the middle mold closing drive portion through the first middle mold closing swing arm and the second middle mold closing swing arm. The left bottom mold mounting plate 12 and the right bottom mold mounting plate 13 are connected to the bottom mold closing drive portion through the first bottom mold closing swing arm and the second bottom mold closing swing arm. The lock mold power transmission seat 35 is connected to the power mounting plate 3. A vertical first guide unit 4 is provided on the side of the power mounting plate 3 close to the lock mold power transmission seat 35. The head mold closing drive portion, the middle mold closing drive portion, and the bottom mold closing drive portion share the left lock mold power rotating shaft 36-1 and the right lock mold power rotating shaft 36-2.

The first lock mold power rotating shaft 36-1 sequentially passes through the inner holes of the lock mold power transmission seat 35, the first head mold closing swing arm 39-1, the first middle mold closing swing arm 38-1, and the first bottom mold closing swing arm 37-1 from top to bottom. Then, the first rotating shaft retaining plate 40-1 and the third rotating shaft retaining plate 40-3 are inserted into the slots at both ends of the first lock mold power rotating shaft 36-1 and fixed on the lock mold power transmission seat 35, allowing the first head mold closing swing arm 39-1, the first middle mold closing swing arm 38-1, and the first bottom mold closing swing arm 37-1 to rotate around the center of the first lock mold power rotating shaft 36-1. The same operation is performed to install the second lock mold power rotating shaft 36-2, the second head mold closing swing arm 39-2, the second middle mold closing swing arm 38-2, and the second bottom mold closing swing arm 37-2 on the other side of the lock mold power transmission seat 35. The first head mold slider pin 61-1 sequentially passes through the small end of the first head mold closing swing arm 39-1 and the inner hole of the first head mold slider 43-1. Then, the second rotating shaft retaining plate 40-2 and the fourth rotating shaft retaining plate 40-4 are used to fix the first head mold slider pin 61-1 on the first head mold closing swing arm 39-1, allowing the first head mold slider 43-1 to rotate around the center of the first head mold slider pin 61-1. The first middle mold slider 44-1 and the first middle mold slider pin 62-1 are fixed on the first middle mold closing swing arm 38-1, allowing the first middle mold slider 44-1 to rotate around the center of the first middle mold slider pin 62-1. The first bottom mold slider 45-1 and the first bottom mold slider pin 63-1 are fixed on the first bottom mold closing swing arm 37-1, allowing the first bottom mold slider 45-1 to rotate around the center of the first bottom mold slider pin 63-1. Similarly, the second head mold slider pin 61-2 sequentially passes through the small end of the second head mold closing swing arm 39-2 and the inner hole of the second head mold slider 43-2. Then, the second head mold slider pin 61-2 is fixed on the second head mold closing swing arm 39-2, allowing the second head mold slider 43-2 to rotate around the center of the second head mold slider pin 61-2. The second middle mold slider 44-2 and the second middle mold slider pin 62-2 are fixed on the second middle mold closing swing arm 38-2, allowing the second middle mold slider 44-2 to rotate around the center of the second middle mold slider pin 62-2. The second bottom mold slider 45-2 and the second bottom mold slider pin 63-2 are fixed on the second bottom mold closing swing arm 37-2, allowing the second bottom mold slider 45-2 to rotate around the center of the second bottom mold slider pin 63-2.

The power mounting plate 3 is fixed on the lock mold power transmission seat 35. The head mold sliders 43 on both sides are placed in the head mold sliding grooves 16-1 that can drive the left head mold mounting plate 10 and the right head mold mounting plate 11 to slide. Driven by the head mold power motor 51, the head mold sliders 43 can slide in the head mold sliding grooves, allowing the left head mold 1-1 and the right head mold 2-1 to move closer or farther away. The middle mold sliders 44 are placed in the middle mold sliding grooves that can drive the left middle mold mounting plate 8 and the right middle mold mounting plate 9 to slide. Driven by the middle mold power motor 53, the middle mold sliders 44 can slide in the middle mold sliding grooves, allowing the left middle mold 1-2 and the right middle mold 2-2 to move closer or farther away. The bottom mold sliders 45 are placed in the bottom mold sliding grooves 16-3 that can drive the left bottom mold mounting plate 12 and the right bottom mold mounting plate 13 to slide. Driven by the bottom mold power motor 55, the bottom mold sliders 45 can slide in the bottom mold sliding grooves, allowing the left bottom mold 1-3 and the right bottom mold 2-3 to move closer or farther away.

The motor support plate 46 is fixed on the lock mold power transmission seat 35. One end of the first motor support rod 47-1 to the third motor support rod 47-3 is fixed on the motor support plate 46. The inner holes of the first hinge seat 48-1 to the third hinge seat 48-3 are sleeved on the first motor support rod 47-1 to the third motor support rod 47-3, respectively, allowing the hinge seats 48 to move back and forth on the first motor support rod 47-1 to the third motor support rod 47-3. The other ends of the first motor support rod 47-1 to the third motor support rod 47-3 are inserted into the mounting holes of the motor mounting plate 49, and then the motor mounting plate 49 is fixed on the first motor support rod 47-1 to the third motor support rod 47-3. The first connecting nuts 60-1 to the third connecting nuts 60-3 are fixed on the first hinge seat 48-1 to the third hinge seat 48-3, respectively. One end of the output shaft of the head mold power transmission assembly 50 passes through the inner hole above the motor mounting plate 49 and is connected to the first connecting nut 60, and the head mold power transmission assembly 50 is fixed on the motor mounting plate 49. The head mold power motor 51 is fixed on the other end of the head mold power transmission assembly 50, allowing the first hinge seat 48-1 connected to the head mold power transmission assembly 50 to move back and forth along the first motor support rod 47-1 under the drive of the head mold power motor 51. The same operation is performed to fix the middle mold power transmission assembly 52 in the middle position of the motor mounting plate 49, allowing the second hinge seat 48-2 connected to the middle mold power transmission assembly 52 to move back and forth along the second motor support rod 47-2 under the drive of the middle mold power motor 53. The bottom mold power transmission assembly 54 is fixed below the motor mounting plate 49, allowing the third hinge seat 48-3 connected to the bottom mold power transmission assembly 54 to move back and forth along the third motor support rod 47-3 under the drive of the bottom mold power motor 55.

Since the head mold, middle mold, and bottom mold are all arranged in pairs with left and right parts, related components such as link pins, hinge seats, and rotating shafts are also arranged in pairs to match the head mold, middle mold, and bottom mold. Only the arrangement on one side is described below, and the arrangement on the other side is the same.

The first head mold link pin 66-1 sequentially passes through the large shaft end of the first head mold closing swing arm 39-1 and the large shaft end inner hole of the first head mold link 56-1. Then, the fifth rotating shaft retaining plate 40-5 is inserted into the slot of the first head mold link pin 66-1 and fixed on the first head mold closing swing arm 39-1, allowing the first head mold link 56-1 to rotate around the center of the first head mold link pin 66-1. The head mold hinge seat pin 64 sequentially passes through the inner holes of the first hinge seat 48-1 and the small shaft end of the first head mold link 56-1. Then, the seventh rotating shaft retaining plate 40-7 is inserted into the slot of the head mold hinge seat pin 64 and fixed on the first hinge seat 48-1, allowing the first head mold closing swing arm 39-1 to rotate around the center of the first lock mold power rotating shaft 36-1 under the drive of the head mold power motor 51. Similarly, the first middle mold link 57, middle mold hinge seat pin 65, and first middle mold link pin 67-1 are used to connect the first middle mold closing swing arm 38-1 and the second hinge seat 48-2, allowing the first middle mold closing swing arm 38-1 to rotate around the center of the first lock mold power rotating shaft 36-1 under the drive of the middle mold power motor 53. The first bottom mold link 58-1, bottom mold hinge seat pin 59, and bottom mold link pin 68 are used to connect the first bottom mold closing swing arm 37-1 and the third hinge seat 48-3, allowing the first bottom mold closing swing arm 37-1 to rotate around the center of the first lock mold power rotating shaft 36-1 under the drive of the bottom mold power transmission assembly 54.

### Vertical Movement Mechanism

The vertical movement mechanism includes a lock mold power transmission seat 35, a lock mold screw 33, and a lock mold power motor 27. The lock mold power motor 27 is connected to the lock mold screw 33-2. The moving nut 33-1 of the lock mold screw 33-2 is equipped with the lock mold power transmission seat 35, which is connected to the mold-closing driving mechanism. The lock mold power motor 27 is arranged below the left mold group and the right mold group. The small shaft end of the second screw body 33-2 of the lock mold screw passes through the inner hole of the lock mold screw bearing 31 and is connected to the output shaft end of the lock mold reducer 25 through the lock mold coupling 29. The lock mold power transmission seat 35 is fixed on the second screw nut 33-1. The large end of the second screw body 33-2 of the lock mold screw passes through the avoidance hole of the lock mold power transmission seat 35. The large shaft end of the second screw body 33-2 is equipped with a screw bearing 42 at its end, which is fixed in the inner hole of the screw bearing seat 41. The screw bearing seat 41 is fixed on the frame (not shown in the figures), allowing the lock mold power transmission seat 35 to move up and down vertically along the second screw body 33-2 under the drive of the lock mold power motor 27.

### Holder

The first guide rail 4-2 of the first guide unit 4 is vertically fixed on the frame (not shown in the figures), and the power mounting plate 3 is fixed on the first slider 4-1, allowing the power mounting plate 3 to move up and down along the first guide rail 4-2. The power mounting plate 3 and the components fixed on it can move up and down vertically along the first guide rail 4-2 of the first guide unit 4.

The holder 69 is installed on the first slider 4-1 of the first guide unit 4 and the holder mounting seat 34, allowing the holder 69 to move up and down vertically along the first guide rail 4-2 under the drive of the holder power motor 26.

Below the left mold group and the right mold group are the holder mounting seat 34, the holder screw 32, and the holder power motor 26. The holder power motor 26 is connected to the holder screw 32. The moving nut of the holder screw 32 is equipped with the holder mounting seat 34, and the holder screw 32 moves with three mold units. The holder mounting seat 34 is equipped with a holder 69 for clamping the perfusion container, as shown in FIG. 11.

The motor fixed seat 20 is fixed on the frame (not shown in the figures). The holder transmission screw bearing seat 21 and the lock mold transmission screw bearing seat 22 are fixed on the motor fixed seat 20. The motor mounting seat 23 is fixed below the holder transmission screw bearing seat 21 and the lock mold transmission screw bearing seat 22. The holder reducer 24 and the lock mold reducer 25 are fixed by the output shaft end on the motor mounting seat 23. The holder power motor 26 is fixed on the input end of the holder reducer 24, and the lock mold power motor 27 is fixed on the input end of the lock mold reducer 25. The holder screw bearing 30 is installed in the bearing hole of the holder transmission screw bearing seat 21, and the lock mold screw bearing 31 is installed in the bearing hole of the lock mold transmission screw bearing seat 22. The small shaft end of the first screw body 32-2 of the holder screw passes through the inner hole of the holder screw bearing 30 and is connected to the output shaft end of the holder reducer 24 through the holder coupling 28. The holder mounting seat 34 is fixed on the first screw nut 32-1. The large shaft end of the first screw body 32-2 of the holder screw passes through the avoidance hole of the lock mold power transmission seat 35. A screw bearing 42 is installed at the end of the large shaft of the first screw body 32-2, which is fixed in the inner hole of the screw bearing seat 41. The screw bearing seat 41 is fixed on the frame (not shown in the figures), allowing the holder mounting seat 34 to move up and down vertically along the first screw body 32-2 under the drive of the holder power motor 26.

After the power mounting plate 3 and the lock mold power transmission seat 35 are fixed together, the power mounting plate 3, the components fixed on the power mounting plate 3, and the components fixed on the lock mold power transmission seat 35 can move up and down vertically along the first guide rail 4-2 under the drive of the lock mold power motor 27.

According to the specific structure of the forming and sealing unit in this embodiment, the action modes of each component are as follows:

When the extruded and inflated tubular blank moves to the middle between the left bottom mold 1-3 and the right bottom mold 2-3, the bottom mold drive portion is controlled to perform a mold closing and shaping action, that is, the bottom mold power motor 55 rotates to extend the piston rod of the bottom mold power transmission assembly 54. The third hinge seat 48-3 moves away from the bottom mold power transmission assembly 54, and the first bottom mold closing swing arm 37-1 and the second bottom mold closing swing arm 37-2 rotate around the centers of the first lock mold power rotating shaft 36-1 and the second lock mold power rotating shaft 36-2, respectively, allowing the left bottom mold mounting plate 12 and the right bottom mold mounting plate 13 to move closer to each other. Then, the left bottom mold 1-3 and the right bottom mold 2-3 clamp and shape the first inflatable tubular blank segment to form the first container body. At the same time, all molds and their mold mounting portions move downward under the drive of the lock mold power motor 27 of the vertical movement mechanism. All molds and the first inflatable tubular blank segment remain synchronized without relative motion, and during this process, the filling unit fills the liquid into the inner cavity of the first container body shaped by the bottom mold through the filling needle. When the entire mold and its mold mounting portion move downward to the position where the filling needle leaves the bottom mold in terms of height, that is, the filling needle enters the cavity height position defined by the left middle mold 1-2 and the right middle mold 2-2, the middle mold drive portion is controlled to perform a mold closing and shaping action, that is, the middle mold power motor 53 rotates to extend the piston rod of the middle mold power transmission assembly 52. The second hinge seat 48-2 moves away from the middle mold power transmission assembly 52, and the first middle mold closing swing arm 38-1 and the second middle mold closing swing arm 38-2 rotate around the centers of the first lock mold power rotating shaft 36-1 and the second lock mold power rotating shaft 36-2, respectively, allowing the left middle mold mounting plate 8 and the right middle mold mounting plate 9 to move closer to each other. Then, the left middle mold 1-2 and the right middle mold 2-2 clamp and shape the second inflatable tubular blank segment to form the second container body and seal the upper part of the first inflatable tubular blank segment corresponding to the bottom mold to generate the first container. At the same time, the entire mold and its mold mounting portion continue to move downward under the drive of the lock mold power motor 27, remaining synchronized with the second inflatable tubular blank segment without relative motion, and the filling unit completes filling the cavity shaped by the middle mold. When the entire mold and its mold mounting portion move downward to the position where the left head mold 1-1 and the right head mold 2-1 leave the filling needle, the head mold drive portion is controlled to perform a mold closing and shaping action, that is, the head mold power motor 51 rotates to extend the piston rod of the head mold power transmission assembly 50. The first hinge seat 48-1 moves away from the head mold power transmission assembly 50, and the first head mold closing swing arm 39-1 and the second head mold closing swing arm 39-2 rotate around the centers of the first lock mold power rotating shaft 36-1 and the second lock mold power rotating shaft 36-2, respectively, allowing the left head mold mounting plate 10 and the right head mold mounting plate 11 to move closer to each other. Then, the left head mold 1-1 and the right head mold 2-1 clamp the upper part of the second inflatable tubular blank segment to shape and seal the middle mold part to form the second container.

After the above production process is completed, the holder 69 clamps the inflatable tubular blank. Then, the bottom mold power motor 55, the middle mold power motor 53, and the head mold power motor 51 rotate in the reverse direction simultaneously, and at the same time, the left head mold 1-1 and the right head mold 2-1, the left middle mold 1-2 and the right middle mold 2-2, and the left bottom mold 1-3 and the right bottom mold 2-3 move in the opposite direction to open the molds. Then, the lock mold power motor 27 rotates in the reverse direction, causing the entire mold mounting portion to move upward. It moves to the initial mold closing position of the left bottom mold 1-3 and the right bottom mold 2-3, and then the holder opens again to achieve periodic production.

The above describes only preferred embodiments of the present invention and is not intended to limit the present invention in any form or substance. It should be pointed out that for those skilled in the art, various modifications and supplements can be made without departing from the spirit and scope of the present invention, and these modifications and supplements should also be regarded as falling within the protection scope of the present invention. All technical personnel familiar with this field can make some minor changes, modifications, and adaptations based on the above-revealed technical content, which are all equivalent embodiments of the present invention. At the same time, any equivalent changes, modifications, and adaptations made based on the essence of the present invention to the above embodiments are still within the scope of the technical solution of the present invention.

1. A dual-mold continuous filling and forming device, characterized in that it comprises:
an inflated tube blank providing unit configured to continuously provide inflated tube blanks;
a molding and sealing unit configured to form sequentially form at least one first container body, seal the at least one first container body to form at least one first container, form at least one second container body, and seal the at least one second container body to form at least one second container;
a filling unit configured to sequentially fill contents into the first container body and the second container at a filling height;
wherein the molding and sealing unit comprises a vertical motion mechanism and a mold-closing driving mechanism coupled to the vertical motion mechanism;
the mold-closing driving mechanism comprises a mold mounting portion and a mold driving portion, wherein the mold mounting portion is used for mounting a head mold, a middle mold, and a bottom mold arranged in sequence corresponding to the shapes of the first container and the second container; the mold driving portion is configured to enable the head mold, middle mold, and bottom mold to be individually controlled for opening and closing, and to enable the entire mold mounting portion to move downward from an initial position under the drive of the vertical motion mechanism to sequentially form the first container body, seal the first container body to form the first container, form the second container body, and seal the second container body to form the second container.

2. The dual-mold continuous filling and forming device according to claim 1, characterized in that: the vertical motion mechanism is configured to, after closing the bottom mold, drive the mold mounting portion downward by a first distance, during which the filling unit fills contents into the formed first container body; and after closing the middle mold, drive the mold mounting portion downward by a third distance, during which the filling unit fills contents into the formed second container body.

3. The dual-mold continuous filling and forming device according to claim 2, characterized in that: the vertical motion mechanism is configured to, after driving the mold mounting portion downward by the first distance, drive the mold mounting portion downward by a second distance and then drive the closing of the middle mold; and after driving the mold mounting portion downward by the third distance, drive the mold mounting portion downward by a fourth distance and then drive the closing of the head mold.

4. The dual-mold continuous filling and forming device according to claim 1, characterized in that: the mold driving portion is configured to drive all molds to open after the formation of the second container; and the vertical motion mechanism is configured to drive the mold mounting portion to return to the initial position after all molds are opened.

5. The dual-mold continuous filling and forming device according to claim 1, characterized in that: it further comprises a protective frame, which is configured to have two rotatable arms, the two rotatable arms are configured to hold the inflated tube blank above the mold holding part before all molds are opened; and hold the inflated tube blank below the mold holding part before the bottom mold is closed.

6. The dual-mold continuous filling and forming device according to claim 1, characterized in that: the mold mounting portion comprises a power mounting plate, a left mold-closing plate, a right mold-closing plate, a left main mold mounting plate with a left main mold, a right main mold mounting plate with a right main mold, a left head mold mounting plate with a left head mold, a right head mold mounting plate with a right head mold, a left bottom mold mounting plate with a left bottom mold, and a right bottom mold mounting plate with a right bottom mold; vertical left mold-closing plate and right mold-closing plate that can move horizontally left and right are respectively arranged on the left and right sides of the vertical power mounting plate;
fixed left main mold mounting plate and right main mold mounting plate are respectively arranged on the left mold-closing plate and right mold-closing plate; left head mold mounting plate and right head mold mounting plate that can move horizontally left and right are respectively arranged on the upper sides of the left main mold mounting plate and right main mold mounting plate; left bottom mold mounting plate and right bottom mold mounting plate that can move horizontally left and right are respectively arranged on the lower sides of the left main mold mounting plate and right main mold mounting plate.

7. The dual-mold continuous filling and forming device according to claim 1, characterized in that: the mold-closing driving mechanism comprises left and right swing arms, left and right lock mold power rotating shafts, left and right swing arm connecting rods, a hinge seat, a support rod, a transmission assembly, and a mold-closing power motor; a vertical lock mold power rotating shaft is respectively arranged on the left and right sides of the lock mold power transmission seat, and left and right swing arms are respectively mounted on the left and right lock mold power rotating shafts; the left and right swing arms are respectively connected to a movable hinge seat through left and right swing arm connecting rods; the hinge seat is movably sleeved on a support rod, and the hinge seat is connected to a mold-closing power motor through the telescopic shaft of the transmission assembly; the left and right swing arms are respectively connected to left and right mold groups; the mold-closing driving mechanisms of the three mold-closing units share the left and right lock mold power rotating shafts.

8. The dual-mold continuous filling and forming device according to claim 1, characterized in that: the vertical motion mechanism comprises a lock mold power transmission seat, a lock mold screw rod, and a lock mold power motor; the lock mold power motor is connected to the lock mold screw rod, and the lock mold power transmission seat is arranged on the moving nut of the lock mold screw rod; the lock mold power transmission seat is connected to the mold-closing driving mechanism.

9. A control method for a dual-mold continuous filling and forming device, characterized in that it comprises the following steps:
first, close a bottom mold to form a first container body from the first section of a continuous inflated tube blank, and after the bottom mold is closed, a vertical motion mechanism drives the entire mold-closing driving mechanism downward by a first distance, and then control a filling needle of the filling unit to fill contents into the first container body;
then, drive the vertical motion mechanism to drive the entire mold-closing driving mechanism downward by a second distance so that the filling needle enters the mold position corresponding to a second container body;
next, drive the closing of a middle mold so that the lower part of the middle mold seals the first container body to form the first container, and at the same time, when the middle mold is closed, the second section of the inflated tube blank above the first section is formed into a second container body, during this process, drive the vertical motion mechanism to drive the entire mold-closing driving mechanism downward by a third distance, and then control the filling needle to fill contents into the second container body;
then, drive the vertical motion mechanism to drive the entire mold-closing driving mechanism downward by a fourth distance so that the filling needle leaves the height position of the second container body, and then drive the closing of the head mold to seal the second container body to obtain the second container with liquid.

10. A molding and sealing unit of a dual-mold continuous filling and forming device, characterized in that: the molding and sealing unit is configured to sequentially form a first container body, seal the first container body to form a first container, form a second container body, and seal the second container body to form a second container; wherein the molding and sealing unit comprises a vertical motion mechanism and a mold-closing driving mechanism coupled to the vertical motion mechanism; the mold-closing driving mechanism comprises a mold mounting portion and a mold driving portion, wherein the mold mounting portion is used for mounting a head mold, a middle mold, and a bottom mold arranged in sequence corresponding to the shapes of the first container and the second container; the mold driving portion is configured to enable the head mold, middle mold, and bottom mold to be individually controlled for opening and closing, and to enable the entire mold mounting portion to move downward under the drive of the vertical motion mechanism to continuously form the first container body, seal the first container body to form the first container, form the second container body, and seal the second container body to form the second container.

11. The molding and sealing unit of the dual-mold continuous filling and forming device according to claim 10, characterized in that: the vertical motion mechanism is configured to, after closing the bottom mold, drive the mold mounting portion downward by a first distance, during which the filling unit fills contents into the formed first container body; and after closing the middle mold, drive the mold mounting portion downward by a third distance, during which the filling unit fills contents into the formed second container body.

12. The molding and sealing unit of the dual-mold continuous filling and forming device according to claim 10, characterized in that: the vertical motion mechanism is configured to, after driving the mold mounting portion downward by the first distance, drive the mold mounting portion downward by a second distance and then drive the closing of the middle mold; and after driving the mold mounting portion downward by the third distance, drive the mold mounting portion downward by a fourth distance and then drive the closing of the head mold.

13. The molding and sealing unit of the dual-mold continuous filling and forming device according to claim 10, characterized in that: the mold driving portion is configured to drive all molds to open after the formation of the second container; and the vertical motion mechanism is configured to drive the mold mounting portion to return to the initial position after all molds are opened.

14. The molding and sealing unit of the dual-mold continuous filling and forming device according to claim 10, characterized in that: it further comprises a protective frame, which is configured to have two rotatable arms, the two rotatable arms are configured to hold at least one inflated tube blank above the mold holding part before all molds are opened; and hold the inflated tube blank below the mold holding part before the bottom mold is closed.

15. The molding and sealing unit of the dual-mold continuous filling and forming device according to claim 10, characterized in that: the mold mounting portion comprises a power mounting plate, a left mold-closing plate, a right mold-closing plate, a left main mold mounting plate with a left main mold, a right main mold mounting plate with a right main mold, a left head mold mounting plate with a left head mold, a right head mold mounting plate with a right head mold, a left bottom mold mounting plate with a left bottom mold, and a right bottom mold mounting plate with a right bottom mold; vertical left and right mold-closing plates that can move horizontally left and right are respectively arranged on the left and right sides of the vertical power mounting plate; fixed left and right main mold mounting plates are respectively arranged on the left and right mold-closing plates; left and right head mold mounting plates that can move horizontally left and right are respectively arranged on the upper sides of the left and right main mold mounting plates; left and right bottom mold mounting plates that can move horizontally left and right are respectively arranged on the lower sides of the left and right main mold mounting plates.

16. The molding and sealing unit of the dual-mold continuous filling and forming device according to claim 10, characterized in that: the mold-closing driving mechanism comprises left and right swing arms, left and right lock mold power rotating shafts, left and right swing arm connecting rods, a hinge seat, a support rod, a transmission assembly, and a mold-closing power motor; a vertical lock mold power rotating shaft is respectively arranged on the left and right sides of the lock mold power transmission seat, and left and right swing arms are respectively mounted on the left and right lock mold power rotating shafts; the left and right swing arms are respectively connected to a movable hinge seat through left and right swing arm connecting rods; the hinge seat is movably sleeved on a support rod, and the hinge seat is connected to a mold-closing power motor through the telescopic shaft of the transmission assembly; the left and right swing arms are respectively connected to left and right mold groups; the mold-closing driving mechanisms of the three mold-closing units share the left and right lock mold power rotating shafts.

17. The molding and sealing unit of the dual-mold continuous filling and forming device according to claim 10, characterized in that: the vertical motion mechanism comprises a lock mold power transmission seat, a lock mold screw rod, and a lock mold power motor; the lock mold power motor is connected to the lock mold screw rod, and a lock mold power transmission seat is arranged on the moving nut of the lock mold screw rod; the lock mold power transmission seat is connected to the mold-closing driving mechanism.
